(19) United States
(12) Patent Application Publication
(10) Pub. No.: US 2015/0131857 A1
(43) Pub. Date: May 14, 2015

(54) VEHICLE RECOGNIZING USER GESTURE AND METHOD FOR CONTROLLING THE SAME

(71) Applicants: Hyundai Motor Company, Seoul (KR); Kia Motors Corpoation, Seoul (KR)

(72) Inventors: Jae Sun Han, Seoul (KR); Ju Hyun Kim, Seoul (KR)

(21) Appl. No.: 14/535,829

(22) Filed: Nov. 7, 2014

(30) Foreign Application Priority Data
Nov. 8, 2013 (KR) 10-2013-0135532

(51) Int. Cl. G06K 9/00

(52) U.S. Cl. CPC G06K 9/00389
USPC 382/103

(57) ABSTRACT

A vehicle is provided that is capable of preventing malfunction or inappropriate operation of the vehicle due to a passenger error by distinguishing a gesture of a driver from that of the passenger when a gesture of a user is recognized, and a method for controlling the same is provided. The vehicle includes an image capturing unit mounted inside the vehicle and configured to capture a gesture image of a gesture area including a gesture of a driver or a passenger. A controller is configured to detect an object of interest in the gesture image captured by the image capturing unit and determine whether the object of interest belongs to the driver. In addition, the controller is configured to recognize a gesture expressed by the object of interest and generate a control signal that corresponds to the gesture when the object of interest belongs to the driver.

### CROSS-REFERENCE TO RELATED APPLICATION

This application claims the benefit of Korean Patent Application No. 2013-0135532, filed on Nov. 8, 2013 in the Korean Intellectual Property Office, the disclosure of which is incorporated herein by reference.

### BACKGROUND

1. Field

The present invention relates to a vehicle that recognizes a gesture of a user and performs a specific function according to the recognized gesture, and a method for controlling the same.

2. Description of the Related Art

As vehicle technologies are developed, in addition to driving which is a basic function of a vehicle, various functions for user convenience are provided. As the function of a vehicle is diversified, a user has increased manipulation loads and the increased manipulation loads reduce concentration on driving, causing safety concerns. Further, a user who is inexperienced in manipulating devices may not be capable of making full use of functions of the vehicle.

Thus, research and development are being conducted on a user interface to reduce manipulation loads of users. In particular, when a gesture recognition technology which allows control of a specific function with a simple gesture is applied to vehicles, effective reduction in manipulation load is expected.

### SUMMARY

Therefore, it is an aspect of the present invention to provide a vehicle that may prevent malfunction or inappropriate (e.g., incorrect) operation of the vehicle due to a passenger error by distinguishing a driver gesture from that of the passenger when a gesture of a user is recognized, and a method for controlling the same. Additional aspects of the invention will be set forth in part in the description which follows and, in part, will be obvious from the description, or may be learned by practice of the invention.

In accordance with one aspect of the present invention, a vehicle may include an image capturing unit (e.g., imaging device, camera, etc.) mounted within the vehicle and configured to capture a gesture image of a gesture area including a driver gesture or a passenger gesture, an image analysis unit configured to detect an object of interest in the gesture image captured by the image capturing unit and determine whether the object of interest is related to the driver, and a controller configured to recognize a gesture expressed by the object of interest and generate a control signal that corresponds to the gesture when the object of interest is related to the driver.

The image analysis unit may be configured to extract a pattern of interest with respect to the object of interest and determine whether the pattern of interest has a predefined feature. The image analysis unit may also be configured to determine that the object of interest is related to the driver (e.g., is that of the driver and not the passenger) when the pattern of interest has the predefined feature. The object of interest may be an arm or a hand of a person. The pattern of interest may include a wrist connection pattern formed by connecting an end of the arm and a wrist which is a connection part between the arm and the hand.

The predefined feature may include a feature in which the wrist connection pattern starts from a left or right side of the gesture area. When the vehicle is a left hand drive (LHD) vehicle, the image analysis unit may be configured to determine that the object of interest belongs to the driver when the wrist connection pattern starts from the left side of the gesture area. When the vehicle is a right hand drive (RHD) vehicle, the image analysis unit may be configured to determine that the object of interest belongs to the driver when the wrist connection pattern starts from the right side of the gesture area.

The pattern of interest may include a first finger pattern formed by connecting a wrist which is a connection part between the arm and the hand, and a thumb end of the hand, and a second finger pattern formed by connecting the wrist and another finger end of the hand. The predefined feature may include a feature in which the first finger pattern is located at a left or right side of the second finger pattern. When the vehicle is an LHD vehicle, the image analysis unit may be configured to determine that the object of interest belongs to the driver when the first finger pattern is located at the left side of the second finger pattern. When the vehicle is an RHD vehicle, the image analysis unit may be configured to determine that the object of interest belongs to the driver if the first finger pattern is located at the right side of the second finger pattern.

The vehicle may further include a memory configured to store specific gestures and specific operations in a mapping mode. The controller may be configured to search the memory for a specific gesture that corresponds to the gesture expressed by the object of interest, and generate a control signal to execute a specific operation mapped to a detected specific gesture. The memory may be executed by the controller to store a specific gesture and an operation to change gesture recognition authority in a mapping mode. The controller may be configured to generate a control signal to change the gesture recognition authority when the gesture expressed by the object of interest corresponds to the specific gesture. The changing of the gesture recognition authority may include extending a holder of the gesture recognition authority to the passenger, and restricting the holder of the gesture recognition authority to the driver.

In accordance with another aspect of the present invention, a method for controlling a vehicle may include capturing, by an imaging device, a gesture image of a gesture area including a driver gesture or a passenger gesture, detecting, by a controller, an object of interest in the captured gesture image of the gesture area, determining, by the controller, whether the object of interest belongs to the driver, and recognizing, by the controller, a gesture expressed by the object of interest and generating, by the controller, a control signal that corresponds to the gesture when the object of interest belongs to the driver.

The method may further include extracting, by the controller, a pattern of interest with respect to the object of interest, and determining, by the controller, that the object of interest belongs to the driver when the pattern of interest has a predefined feature. The object of interest may be an arm or a hand of a person, and the pattern of interest may include a wrist connection pattern formed by connecting an end of the arm and a wrist which is a connection part between the arm and the hand.

The predefined feature may include a feature in which the wrist connection pattern starts from a left or right side of the gesture area. The object of interest may be an arm or a hand of a person, and the pattern of interest may include a first finger pattern formed by connecting a wrist which is a connection part between the arm and the hand, and a thumb end of the hand, and a second finger pattern formed by connecting the wrist and another finger end of the hand. The predefined feature may include a feature in which the first finger pattern is located at a left or right side of the second finger pattern.

### BRIEF DESCRIPTION OF THE DRAWINGS

These and/or other aspects of the invention will become apparent and more readily appreciated from the following description of the exemplary embodiments, taken in conjunction with the accompanying drawings of which:

FIG. 1 is an exemplary external view of a vehicle according to an exemplary embodiment of the present invention;

FIG. 2 is an exemplary block diagram of the vehicle, according to an exemplary embodiment of the present invention;

FIG. 3 illustrates an exemplary internal configuration of the vehicle, according to an exemplary embodiment of the present invention;

FIG. 4 illustrates an exemplary gesture area to be photographed by an image capturing unit according to an exemplary embodiment of the present invention;

FIG. 5 illustrates an exemplary embodiment in which the image capturing unit is mounted on a headlining of the vehicle according to an exemplary embodiment of the present invention;

FIG. 6 illustrates an exemplary embodiment in which the image capturing unit is mounted on a center console of the vehicle according to an exemplary embodiment of the present invention;

FIGS. 7 to 9 illustrate exemplary pattern analysis performed by an image analysis unit to identify a driver according to an exemplary embodiment of the present invention;

FIG. 10 is an exemplary block diagram of the vehicle including an audio video navigation (AVN) device, according to an exemplary embodiment of the present invention;

FIG. 11 is an exemplary block diagram of the vehicle including an air conditioning device, according to an exemplary embodiment of the present invention;

FIG. 12 illustrates an exemplary specific gesture to extend a holder of gesture recognition authority to a passenger according to an exemplary embodiment of the present invention;

FIG. 13 illustrates an exemplary pattern analysis performed by the image analysis unit to identify a passenger when gesture recognition authority is further given to the passenger according to an exemplary embodiment of the present invention;

FIGS. 14 and 15 illustrate an exemplary specific gesture to retrieve the gesture recognition authority from the passenger according to an exemplary embodiment of the present invention; and

FIG. 16 is an exemplary flowchart of a method for controlling the vehicle, according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference will now be made in detail to the exemplary embodiments of the present invention, examples of which are illustrated in the accompanying drawings, wherein like reference numerals refer to like elements throughout.

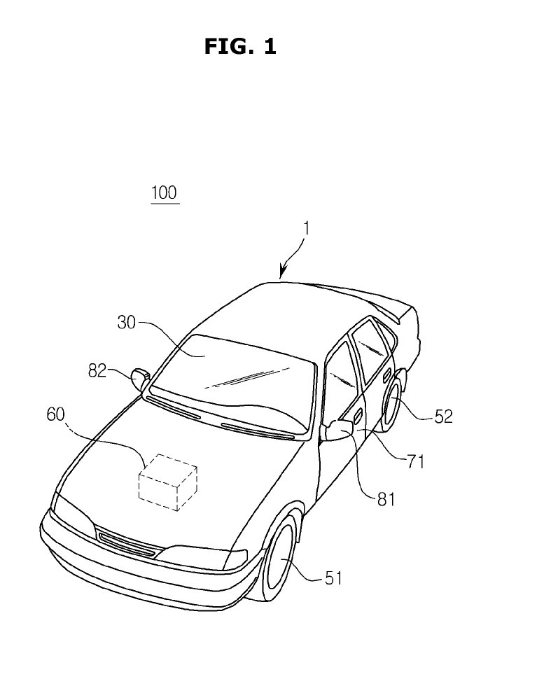

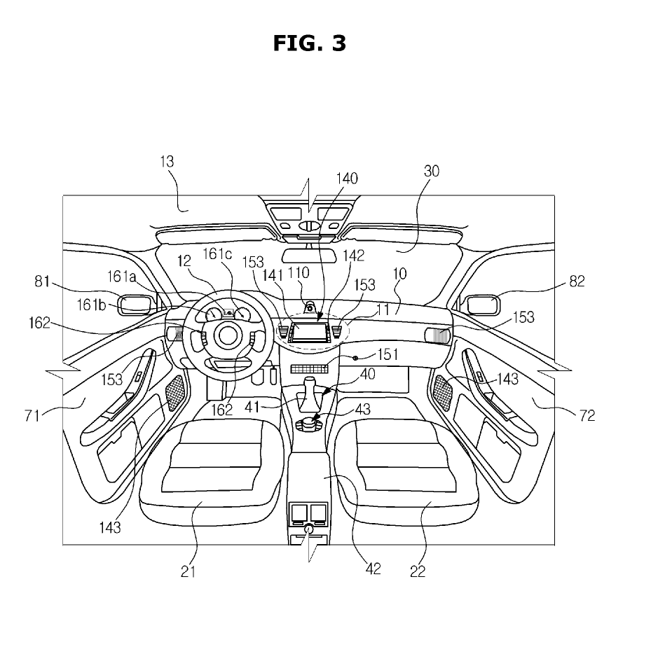

FIG. 1 is an exemplary external view of a vehicle 100 according to an exemplary embodiment of the present invention. Referring to FIG. 1, the vehicle 100 may include a body 1 that forms an exterior of the vehicle 100, a plurality of wheels 51 and 52 configured to move the vehicle 100, a drive unit 60 configured to rotate the wheels 51 and 52, a plurality of doors 71 and 72 (see FIG. 3) configured to isolate an internal space of the vehicle 100 from an external environment, a windshield glass 30 configured to provide a view in front of the vehicle 100 to a driver inside the vehicle 100, and a plurality of side-view mirrors 81 and 82 configured to provide a view behind the vehicle 100 to the driver.

The wheels 51 and 52 may include front wheels 51 disposed at a front part of the vehicle 100 and rear wheels 52 disposed at a rear part of the vehicle 100, and the drive unit 60 may be configured to provide torque to the front wheels 51 or the rear wheels 52 to move the body 1 in the forward or backward direction. The drive unit 60 may use an engine to generate torque by burning fossil fuel or a motor to generate torque by receiving electricity from a capacitor (not shown).

The doors 71 and 72 may be rotatably disposed at left and right sides of the body 1 to allow the driver to enter the vehicle 100 in an open state thereof and to isolate the internal space of the vehicle 100 from an external environment in a closed state thereof. The windshield glass 30 may be disposed at a top front part of the body 1 to allow the driver inside the vehicle 100 to acquire visual information in front of the vehicle 100. The side-view mirrors 81 and 82 may include a left side-view mirror 81 disposed at the left side of the body 1 and a right side-view minor 82 disposed at the right side of the body 1, and allow the driver inside the vehicle 100 to acquire visual information beside or behind the vehicle 100.

In addition, the vehicle 100 may include a plurality of sensing devices such as a proximity sensor configured to sense an obstacle or another vehicle behind or beside the vehicle 100 (e.g., the traveling vehicle 100), and a rain sensor configured to sense rain and an amount of rain. The proximity sensor may be configured to transmit a sensing signal to a side or the back of the vehicle 100, and receive a reflection signal reflected from an obstacle such as another vehicle. The proximity sensor may also be configured to sense whether an obstacle is present beside or behind the vehicle 100, and detect the location of the obstacle based on the waveform of the received reflection signal. For example, the proximity sensor may use a scheme for transmitting an ultrasonic wave and detecting the distance to an obstacle using the ultrasonic wave reflected from the obstacle.

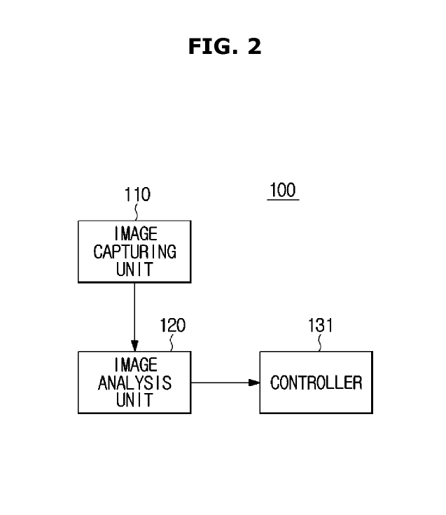

FIG. 2 is an exemplary block diagram of the vehicle 100, according to an exemplary embodiment of the present invention. Referring to FIG. 2, the vehicle 100 may include an image capturing unit 110 (e.g., an imaging device, a camera, a video camera, etc.) configured to capture an image of a specific area within the vehicle 100, an image analysis unit 120 configured to detect an object of interest in the captured image and determine whether the detected object of interest belongs to a driver, a controller 131 configured to recognize a gesture expressed by the object of interest and generate a control signal that corresponds to the recognized gesture when the detected object of interest belongs to the driver, and a memory 132 configured to store gestures and events corresponding to the gestures. The controller 131 may be configured to operate the image analysis unit 120. In an exemplary embodiment of the present invention, a user may include the driver and a passenger in the vehicle 100.

The image capturing unit 110 may be mounted within the vehicle 100 to capture an image of a specific area which may include a body part of the driver performing a gesture. In the following description, the specific area is referred to as a gesture area and the image captured by the image capturing unit 110 is referred to as a gesture image. The image capturing unit 110 may include an image sensor such as a charge-coupled device (CCD) sensor or a complementary metal-oxide-semiconductor (CMOS) sensor, and may be capable of infrared imaging when the image sensor has sufficient sensitivity in an infrared range. In other words, the image capturing unit 110 may be implemented as an infrared camera as well as a general imaging device.

When the image capturing unit 110 is implemented as an infrared camera, an infrared light source configured to irradiate a subject with infrared light may be further provided and thus the image sensor may be configured to sense infrared light reflected from the subject. An example of the infrared light source may be an infrared light emitting diode (LED). Alternatively, a separate infrared light source may not be provided and infrared light generated by the subject itself may be sensed.

The image capturing unit 110 may further include a lens configured to receive the gesture image as an optical signal, and an image analog to digital (A/D) converter to convert an electrical signal into a data-processable digital signal after the image sensor converts and outputs the optical signal received by the lens, into the electrical signal. In addition, when the image capturing unit 110 is implemented as an infrared camera, an infrared filter configured to remove external noise by blocking non-infrared light, e.g., ultraviolet light or visible light, may be further provided.

An exemplary gesture performed by the driver while driving may be an arm or hand gesture. Accordingly, a gesture recognizable by the controller 131 may be an arm or hand gesture of the driver, and an object of interest detected by the image analysis unit 120 may be an arm or a hand of the driver. A description is now given of the location of the image capturing unit 110 to capture an image including an arm or a hand of the driver.

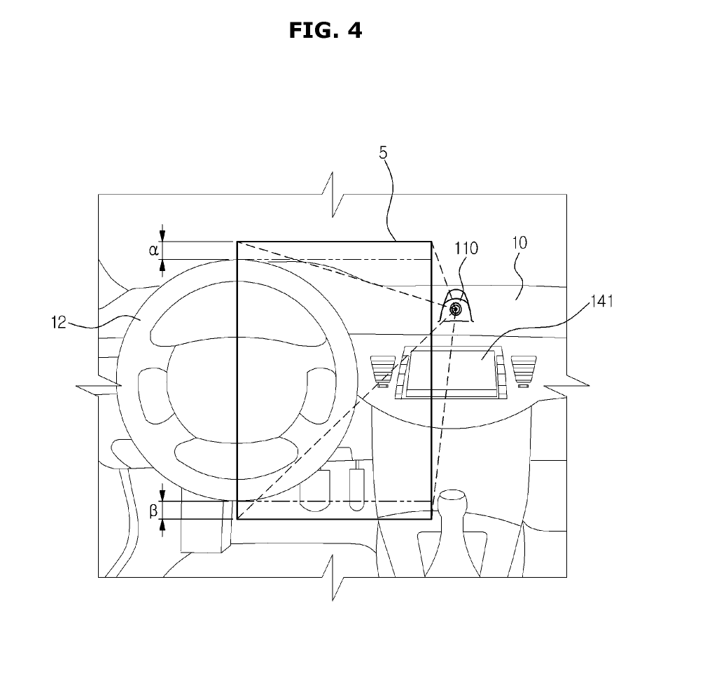

FIG. 3 illustrates an internal configuration of the vehicle 100, according to an exemplary embodiment of the present invention, and FIG. 4 illustrates a gesture area to be photographed by the image capturing unit 110. Referring to FIG. 3, the image capturing unit 110 may be mounted on a dashboard 10 at a front part of the vehicle 100 to capture an image of a hand of the driver.

An audio video navigation (AVN) device 140 including an AVN display 141 and an AVN input unit 142 may be provided on a center fascia 11 which is a substantially central area of the dashboard 10. The AVN device 140 is a device configured to integrally perform audio, video and navigation functions, and the AVN display 141 may be configured to selectively display at least one of audio, video and navigation screens and may be implemented as a liquid crystal display (LCD), a light emitting diode (LED), a plasma display panel (PDP), an organic light emitting diode (OLED), a cathode ray tube (CRT), etc.

The user may manipulate the AVN input unit 142 to input a command to operate the AVN device 140. The AVN input unit 142 may be disposed near (e.g., adjacent to) the AVN display 141 in the form of hard keys as illustrated in FIG. 3. Alternatively, when the AVN display 141 is implemented as a touchscreen, the AVN display 141 may further function as the AVN input unit 142. A speaker 143 configured to output sound may be disposed within the vehicle 100, and sound necessary for audio, video and navigation functions may be output from the speaker 143.

A steering wheel 12 may be disposed on the dashboard 10 in front of a driver seat 21, a speed gauge 161b configured to indicate a current speed of the vehicle 100 and a revolutions per minute (RPM) gauge 161c configured to indicate RPM of the vehicle 100 may be disposed on the dashboard 10 near (e.g., adjacent to) the steering wheel 12, and a cluster display 161a configured to display information regarding the vehicle 100 on a digital screen may be further be disposed on the dashboard 10 near (e.g., adjacent to) the steering wheel 12.

A cluster input unit 162 may be disposed on the steering wheel 12 to receive a user selection with respect to information to be displayed on the cluster display 161a. Since the cluster input unit 162 may be manipulated by the driver even while driving, the cluster input unit 162 may be configured to receive a command to operate the AVN device 140 as well as the user selection with respect to information to be displayed on the cluster display 161a. A center input unit 43 may be disposed on a center console 40 in the form of a jog shuttle or hard keys. The center console 40 refers to a part which is disposed between the driver seat 21 and a passenger seat 22 and on which a gear manipulation lever 41 and a tray 42 are formed. The center input unit 43 may be configured to perform all or some functions of the AVN input unit 142 or the cluster input unit 162.

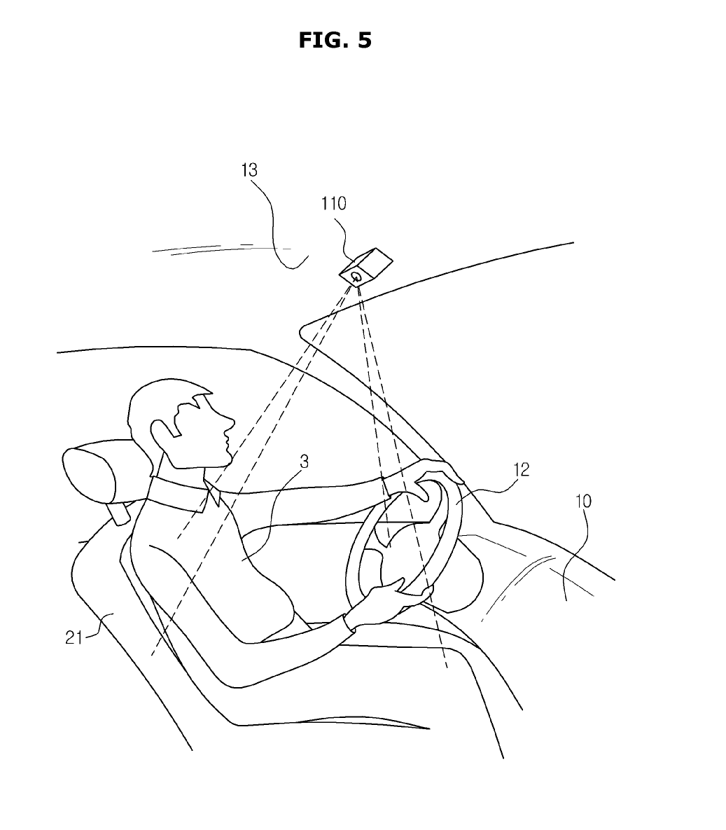

A detailed description is now given of the location of the image capturing unit 110 with reference to FIG. 4. For example, as illustrated in FIG. 4, a gesture area 5 may extend horizontally in the rightward direction from the center of the steering wheel 12 to point slightly tilted (by about 5°) from the center of the AVN display 141 toward the driver seat 21. The gesture area 5 may extend vertically from (a top point of the steering wheel 12 +α) to (a bottom point of the steering wheel 12 +β). Here, +α and +β are given in consideration of to upward and downward tilting angles of the steering wheel 12, and may have equal or different values. The gesture area 5 of FIG. 4 may be set based on a fact that a right hand of a driver 3 (see FIG. 5) is typically located within a certain radius from the steering wheel 12. The right hand of the driver 3 may be photographed when the vehicle 100 is a left hand drive (LHD) vehicle, i.e., that the steering wheel 12 is on the left side. When the vehicle 100 is a right hand drive (RHD) vehicle, the gesture area 5 may extend horizontally in the leftward direction from the center of the steering wheel 12. The gesture area 5 of FIG. 4 is merely an exemplary area to be photographed by the image capturing unit 110, and is not limited thereto as long as a hand of the driver 3 is included in a captured image.

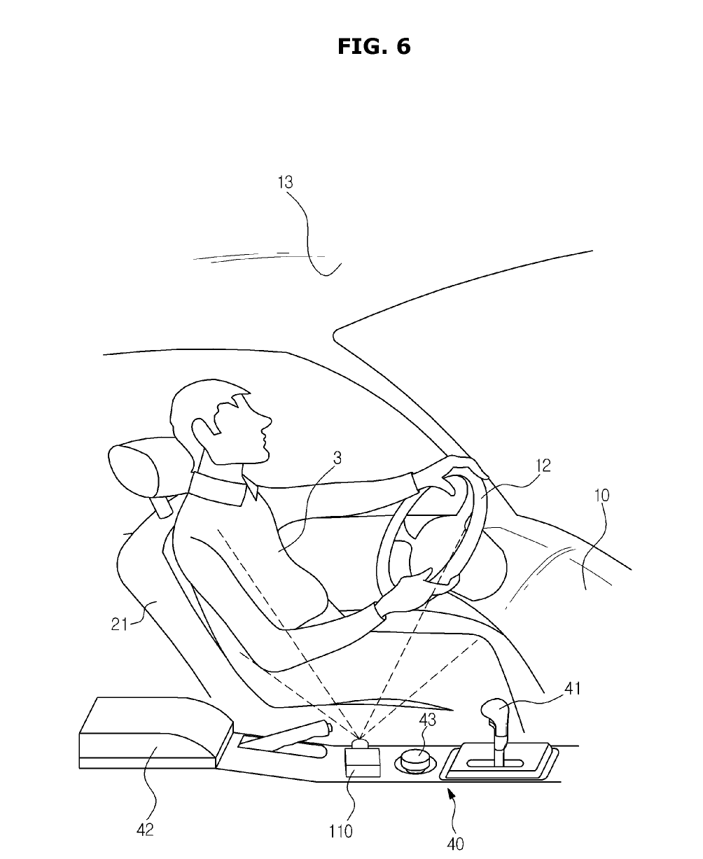

The image capturing unit 110 may be mounted at a location where the gesture area 5 is photographable (e.g., capable of being photographed or captured), and the location of the image capturing unit 110 may be determined in consideration of an angle of view of the image capturing unit 110 in addition to the gesture area 5. FIG. 5 illustrates an exemplary embodiment in which the image capturing unit 110 is mounted on a headlining 13 of the vehicle 100, and FIG. 6 illustrates an exemplary embodiment in which the image capturing unit 110 is mounted on the center console 40 of the vehicle 100. The image capturing unit 110 may be mounted on a location other than the dashboard 10 as long as the gesture area 5 is photographable. For example, the image capturing unit 110 may be mounted on the headlining 13 as illustrated in FIG. 5, or on the center console 40 as illustrated in FIG. 6.

However, when the image capturing unit 110 is mounted on the headlining 13 or the center console 40, the gesture area 5 may be different from that of FIG. 4. In particular, for example, like FIG. 4, the gesture area 5 may extend horizontally in the rightward direction from the center of the steering wheel 12 to point slightly tilted (by about 5°) from the center of the AVN display 141 toward the driver seat 21. However, unlike FIG. 4, the gesture area 5 may extend vertically from the dashboard 10 to the tray 42 of the center console 40.

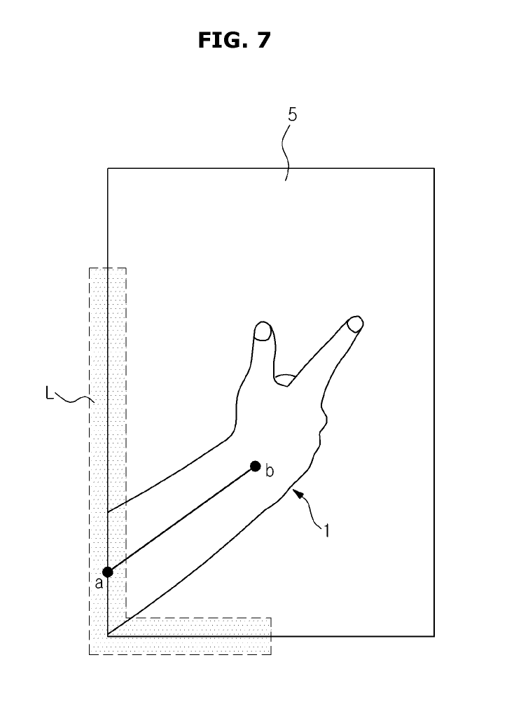

FIGS. 7 to 9 illustrate exemplary pattern analysis performed by the image analysis unit 120 to identify the driver 3. When the image capturing unit 110 captures a gesture image of the gesture area 5, the captured gesture image may include a hand of a passenger in the passenger seat 22 or a back seat as well as a hand of the driver 3, or include a hand of the passenger without including a hand of the driver 3. In particular, when the controller 131 recognizes a gesture expressed by the hand of the passenger and executes an operation corresponding thereto, inappropriate operation or malfunction of the vehicle 100 may be caused differently from the intention of the driver 3. Accordingly, the image analysis unit 120 may be configured to identify whether the hand included in the gesture image is that of the driver 3 or the passenger, and allow the controller 131 to recognize a gesture when the hand is that of the driver 3 (e.g., and not that of the passenger). In other words, the controller may be capable of recognizing the driver gesture, the passenger gesture, or both.

As described above, an object of interest detected by the image analysis unit 120 may be an arm or a hand of the driver. Accordingly, information regarding features of arms and hands to be included in the gesture image information regarding features of fingers may be stored in the memory 132. The memory 132 may include at least one memory device configured to input and output information, for example, a hard disk, flash memory, read only memory (ROM), or an optical disc drive.

The image analysis unit 120 may be configured to detect an object of interest in the gesture image based on the information stored in the memory 132. For example, the image analysis unit 120 may be configured to detect an object having a particular outline based on pixel values of the gesture image, recognize the detected object as an arm and a hand of the user when the detected object has features of the arm and the hand of the user stored in the memory 132, and recognize a connection part between the arm and the hand of the user as a wrist.

When the gesture image is a color image, an object having a particular outline may be detected based on color information (e.g., skin color information) included in pixel values. When the gesture image is an infrared image, an object having a particular outline may be detected based on brightness information included in pixel values. When the object of interest is detected, the image analysis unit 120 may be configured to extract a pattern of interest with respect to the detected object of interest. The pattern of interest may include a wrist connection pattern formed by connecting a specific point of the arm and a wrist point, a finger pattern indicating the relationship between fingers, etc.

Specifically, as illustrated in FIG. 7, the image analysis unit 120 may be configured to extract a wrist connection pattern a-b formed by connecting an arm end point a in the gesture area 5 and a wrist point b, as the pattern of interest. The image analysis unit 120 may be configured to determine whether the extracted wrist connection pattern a-b has a predefined feature, and determine that a corresponding object 1 of interest is that of the driver when the wrist connection pattern a-b has the predefined feature. When the vehicle 100 is an LHD vehicle, a hand of the driver may be predicted to enter the gesture area 5 from the left side. Accordingly, the image analysis unit 120 may be configured to determine whether the wrist connection pattern a-b starts from the left side of the gesture area 5.

For example, when the arm end point a is located in a left boundary area L of the gesture area 5, the image analysis unit 120 may be configured to determine that the wrist connection pattern a-b starts from the left side of the gesture area 5, and determine that the detected object 1 of interest is that of the driver. In particular, the left boundary area L may include a lower part of a left edge of the gesture area 5 and a left part of a bottom edge of the gesture area 5. However, in some cases, the arm of the driver may be fully included in the gesture area 5 and thus not cross a boundary area of the gesture area 5. Accordingly, even when the arm end point a is not located in the left boundary area L of the gesture area 5, when the arm end point a is located at the left side of the wrist point b, the image analysis unit 120 may be configured to determine that the object 1 of interest is that of the driver.

In some other cases, only the hand of the driver may be included in the gesture area 5. Accordingly, even when the gesture image does not have the arm end point a, when the hand of the user crosses the left boundary area L of the gesture area 5 or when the wrist point b is located in the left boundary area L, the image analysis unit 120 may be configured to determine that the object 1 of interest belongs to the driver. Alternatively, the image analysis unit 120 may be configured to determine whether the wrist connection pattern a-b starts from the left side of the gesture area 5. However, to improve the accuracy of identifying the driver, a driver identification algorithm may be additionally used. The image analysis unit 120 may be configured to primarily determine whether the wrist connection pattern a-b starts from the left side of the gesture area 5, and secondarily determine whether the object 1 of interest belongs to the driver, using a finger pattern.

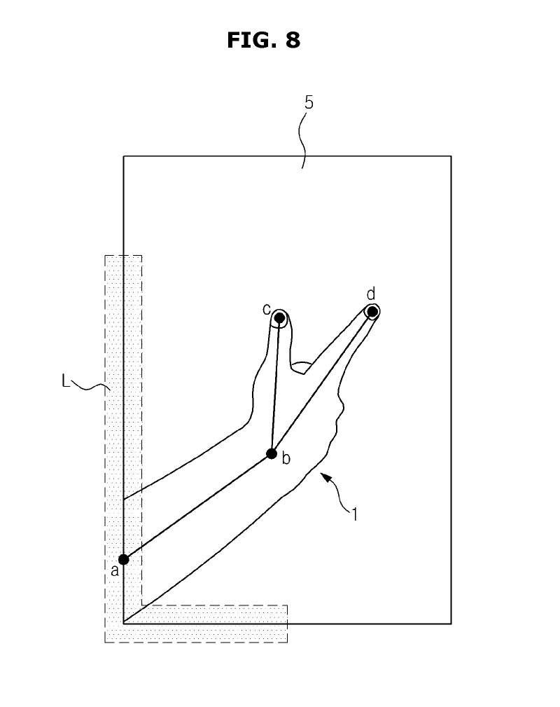

Accordingly, the image analysis unit 120 may be configured to extract a finger pattern from the gesture image. According to the example of FIG. 8, the finger pattern may include a first finger pattern b-c formed by connecting the wrist point b and a thumb end point c, and a second finger pattern b-d formed by connecting the wrist point b and another finger end point d. When the first finger pattern b-c is located at the left side of the second finger pattern b-d, the image analysis unit 120 may be configured to determine that the object 1 of interest in the gesture image belongs to the driver.

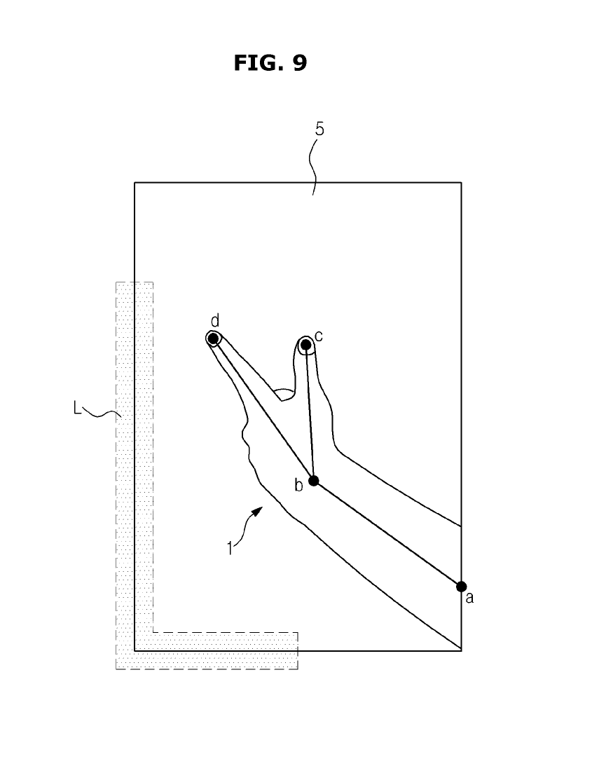

A description is now given of a case that the object 1 of interest does not belong to the driver (e.g., is that of the passenger), with reference to FIG. 9. When the image capturing unit 110 photographs the gesture area 5 illustrated in FIG. 9, since the wrist connection pattern a-b does not start from the left boundary area L, the image analysis unit 120 may be configured to determine that the object 1 of interest is not that of the driver. In addition, since the first finger pattern b-c is located at the right side of the second finger pattern b-d, the image analysis unit 120 may be configured to determine that the object 1 of interest is not that of the driver.

When the image analysis unit 120 identifies the driver using the above two algorithms, the order of the algorithms may be switched or only one algorithm may be used. Specifically, the image analysis unit 120 may be configured to initially determine whether the object 1 of interest belongs to the driver, using a finger pattern, and determine once again using a wrist connection pattern only upon determining that the object 1 of interest belongs to the driver. Alternatively, only the finger pattern or the wrist connection pattern may be used. Even when the gesture area 5 includes a hand of the driver and a hand of the passenger, a pattern of interest of the hand of the driver may be distinguished from that of the hand of the passenger using the above-described algorithms.

The driver identification algorithms described above in relation to FIGS. 7 to 9 may be applicable when the vehicle 100 is an LHD vehicle. When the vehicle 100 is an RHD vehicle, the image analysis unit 120 may be configured to determine that the object 1 of interest in the gesture image belongs to the driver, when a wrist connection pattern starts from a right boundary area of the gesture area 5 or when a first finger pattern is located at the right side of a second finger pattern.

The above-described algorithms are merely exemplary algorithms to be applied to the image analysis unit 120, and exemplary embodiments of the present invention are not limited thereto. Accordingly, a pattern other than a wrist connection pattern or a finger pattern may be set as a pattern of interest, and whether the object 1 of interest belongs to the driver may be determined using another feature of the wrist connection pattern or the finger pattern.

Moreover, the gesture image may include a passenger hand in a back seat as well as a passenger hand in the passenger seat 22. When the passenger in the back seat is located behind the driver seat 21, a hand of the driver may not be distinguished from the hand of the passenger using the directivity of a pattern of interest. Accordingly, the vehicle 100 may distinguish the driver and the passenger using distance information between the image capturing unit 110 and a subject. When the image capturing unit 110 is implemented as an infrared camera including an infrared light source, a subject located within a predetermined distance may be photographed by adjusting a threshold value of a signal sensed by an image sensor. Alternatively, the image analysis unit 120 may be configured to determine an area in which pixel values are equal to or greater than a predefined reference value, as an area where the hand of the driver is located.

Alternatively, the image capturing unit 110 may be implemented as a three-dimensional (3D) camera to include depth information in a gesture image. The image analysis unit 120 may be configured to detect a pattern of interest with respect to the object 1 of interest located within a predetermined distance from the image capturing unit 110, and thus the hand of the passenger in the back seat may be filtered out (e.g., eliminated). Upon determining that the object 1 of interest in the gesture image belongs to the driver, the controller 131 may be configured to recognize a gesture expressed by the object 1 of interest, and generate a control signal that corresponds to the recognized gesture. The gesture recognizable by the controller 131 may be defined to include both a static pose and a dynamic motion.

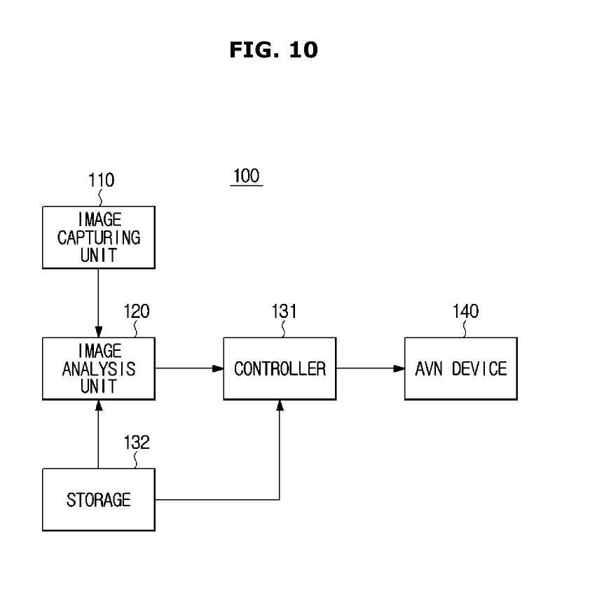

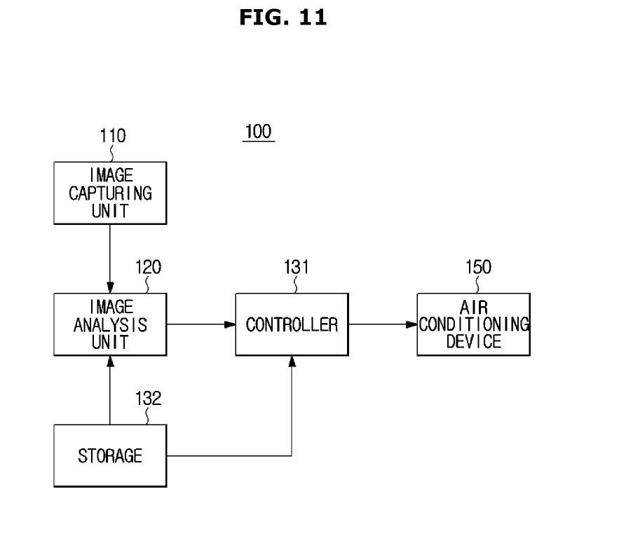

The controller 131 may be configured to recognize a gesture expressed by the object of interest, using at least one of known gesture recognition technologies. For example, when a motion expressed by the hand of the driver is recognized, a motion pattern that indicates a motion of the hand may be detected from the gesture image, and whether the detected motion pattern corresponds to a motion pattern stored in the memory 132 may be determined. To determine the correspondence between the two patterns, the controller 131 may use one of various algorithms such as Dynamic Time Warping (DTW) and Hidden Markov Model (HMM). The memory 132 may be configured to store specific gestures and events that correspond to the gestures, in a mapping mode. Accordingly, the controller 131 may be configured to search the memory 132 for a specific gesture that corresponds to the gesture recognized in the gesture image, and generate a control signal to execute an event that corresponds to a detected specific gesture. A detailed description is now given of operation of the controller 131 with reference to FIGS. 10 and 11.

FIG. 10 is an exemplary block diagram of the vehicle 100 that includes the AVN device 140, according to an exemplary embodiment of the present invention, and FIG. 11 is an exemplary block diagram of the vehicle 100 including an air conditioning device 150, according to an exemplary embodiment of the present invention. Referring to FIG. 10, the vehicle 100 may include the AVN device 140 configured to perform audio, video and navigation functions. Referring back to FIG. 3, the AVN device 140 may include the AVN display 141 configured to selectively display at least one of audio, video and navigation screens, the AVN input unit 142 configured to input a control command regarding the AVN device 140, and the speaker 143 configured to output sound necessary for each function.

When a driver operating the vehicle 100 manipulates the AVN input unit 142 to input a control command regarding the AVN device 140, driving concentration may be reduced and thus safety concerns may be caused. Accordingly, operations of the AVN device 140 may be stored in the memory 132 as the events that correspond to the specific gestures to be expressed by the hand of the driver.

Various types of gestures mapped to different operations of the AVN device 140 may be stored in the memory 132. For example, gesture 1 may be mapped to an operation to turn on the audio function, gesture 2 may be mapped to (e.g., may correspond to) an operation to turn on the video function, and gesture 3 may be mapped to an operation to turn on the navigation function. When the gesture recognized by the controller 131 is gesture 1, the controller 131 may be configured to generate a control signal to turn on the audio function and transmit the control signal to the AVN device 140. When the gesture recognized by the controller 131 is gesture 2 or gesture 3, the controller 131 may be configured to generate a control signal to turn on the video function or the navigation function and transmit the control signal to the AVN device 140.

Alternatively, when at least two of the audio, video and navigation functions are performed, a specific gesture and an operation to switch a screen displayed on the AVN display 141 may be stored in a mapping mode. For example, an operation to switch to an audio screen may be mapped to gesture 4, and an operation to switch to a navigation screen may be mapped to gesture 5. Accordingly, when the gesture recognized by the controller 131 is gesture 4, the controller 131 may be configured to generate a control signal to switch the screen displayed on the AVN display 141 to the audio screen and transmit the control signal to the AVN device 140. When the gesture recognized by the controller 131 is gesture 5, the controller 131 may be configured to generate a control signal to switch the screen displayed on the AVN display 141 to the navigation screen and transmit the control signal to the AVN device 140.

Referring to FIG. 11, the vehicle 100 may include the air conditioning device 150 configured to adjust the temperature within the vehicle 100, and the controller 131 may be configured to adjust the temperature within the vehicle 100 by operating the air conditioning device 150. The air conditioning device 150 may be configured to heat or cool an internal space of the vehicle 100, and adjust the temperature inside the vehicle 100 by providing heated or cooled air through vents 153 (e.g., increase or decrease the internal temperature of the vehicle).

Operation of the air conditioning device 150 of the vehicle 100 is well known, and thus a further detailed description thereof is omitted here. To adjust the temperature within the vehicle 100 using the air conditioning device 150, a user may manipulate an air-conditioning input unit 151 disposed on the center fascia 11 as illustrated in FIG. 3. However, manipulation of the air-conditioning input unit 151 while driving may cause safety concerns and, on substantially cold or hot days, the user needs to rapidly adjust the temperature inside the vehicle 100 to a desired temperature upon entering the vehicle 100.

Accordingly, operations of the air conditioning device 150 may be stored in the memory 132 as the events that correspond to the specific gestures to be expressed by the hand of the driver. For example, gesture 1 stored in the memory 132 may be mapped to an operation to adjust the temperature within the vehicle 100 to a preset temperature, gesture 2 may be mapped to an operation to adjust the temperature within the vehicle 100 to a minimum temperature, and gesture 3 may be mapped to an operation to adjust the temperature within the vehicle 100 to a maximum temperature.

When the gesture recognized by the controller 131 is gesture 1, the controller 131 may be configured to generate a control signal to adjust the temperature within the vehicle 100 to the preset temperature and transmit the control signal to the air conditioning device 150. When the gesture recognized by the controller 131 is gesture 2, the controller 131 may be configured to generate a control signal to adjust the temperature within the vehicle 100 to the minimum temperature and transmit the control signal to the air conditioning device 150. When the gesture recognized by the controller 131 is gesture 3, the controller 131 may be configured to generate a control signal to adjust the temperature within the vehicle 100 to the maximum temperature and transmit the control signal to the air conditioning device 150.

The above-described operations of the AVN device 140 and the air conditioning device 150 are merely exemplary operations to be mapped to the specific gestures, and exemplary embodiments of the present invention are not limited thereto. In addition to the AVN device 140 and the air conditioning device 150, specific gestures and operations of any device controllable by the user by inputting a command may be stored in a mapping mode.

Meanwhile, gesture recognition authority restricted to a driver may be changed. The gesture recognition authority may be further provided to a passenger or the provided authority may be retrieved. The gesture recognition authority may be changed due to user manipulation of various input units (142, 43 and 162) disposed within the vehicle 100, or through gesture recognition.

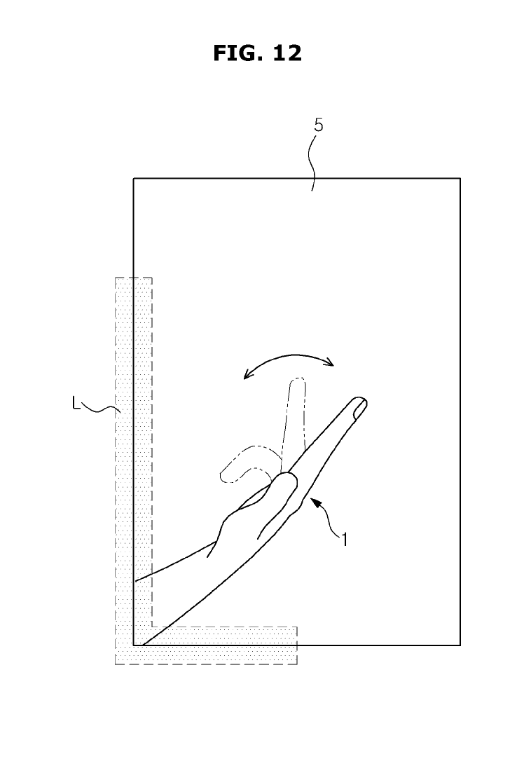

FIG. 12 illustrates an exemplary specific gesture to extend a holder of gesture recognition authority to a passenger. To change the gesture recognition authority, a specific gesture and an operation to change the gesture recognition authority may be stored in the memory 132 in a mapping mode. For example, a gesture in which an index finger is spread toward the passenger seat, i.e., rightward direction, and the other fingers are bent, and an operation to give gesture recognition authority to the passenger in the passenger seat may be stored in the memory 132 in a mapping mode.

Accordingly, as illustrated in FIG. 12, when the object 1 of interest belongs to the driver and a gesture expressed by the object 1 of interest is a pose in which an index finger points toward the passenger seat, i.e., rightward direction, and the other fingers are bent, the controller 131 may be configured to recognize the gesture expressed by the object 1 of interest and extend a holder of the gesture recognition authority to the passenger in the passenger seat. In other words, the gesture recognition authority may be further provided to the passenger (e.g., gestures of the passenger may thus be recognized). When the gesture recognition authority is further provided to the passenger, the image analysis unit 120 may be configured to determine whether the object 1 of interest belongs to the driver or the to passenger. Even when the object 1 of interest does not belong to the driver but belongs to the passenger, the controller 131 may be configured to recognize the gesture expressed by the object 1 of interest and generate a control signal to execute an operation corresponding thereto.

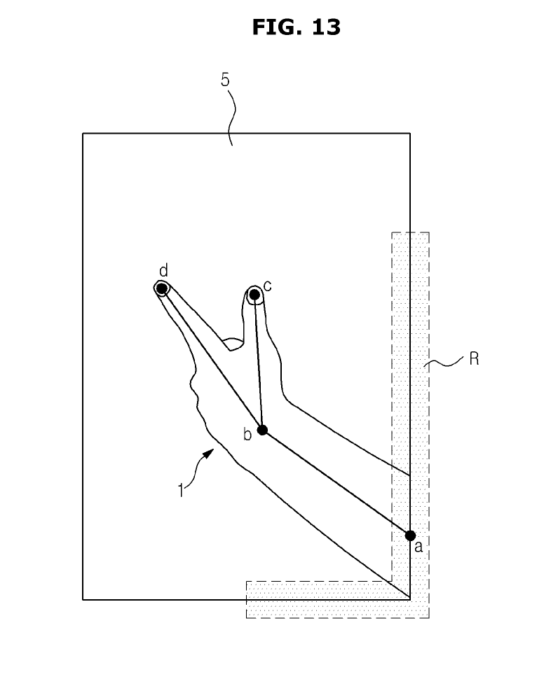

FIG. 13 illustrates an exemplary pattern analysis performed by the image analysis unit 120 to identify a passenger when gesture recognition authority is further provided to the passenger. When the gesture recognition authority is further provided to the passenger, the image analysis unit 120 may be configured to determine to whom the object 1 of interest belongs, by applying a criterion used when the gesture recognition authority is provided to the driver only, and an opposite criterion thereof together. For example, when the gesture recognition authority is provided to the driver, as illustrated in FIG. 7, the driver may be identified based on whether the wrist connection pattern a-b starts from the left boundary area L of the gesture area 5 or whether the first finger pattern b-c is located at the left side of the second finger pattern b-d.

However, when the gesture recognition authority is provided to the passenger, as illustrated in FIG. 13, the passenger may be identified based on whether the wrist connection pattern a-b starts from a right boundary area R of the gesture area 5 or whether the first finger pattern b-c is located at the right side of the second finger pattern b-d. In other words, when the wrist connection pattern a-b starts from the right boundary area R of the gesture area 5 or when the first finger pattern b-c is located at the right side of the second finger pattern b-d, the image analysis unit 120 may be configured to determine that the object 1 of interest belongs to the passenger.

Even when the object 1 of interest in the gesture area 5 belongs to the passenger rather than the driver, the controller 131 may be configured to recognize a gesture expressed by the object 1 of interest and execute an operation corresponding thereto. Meanwhile, the holder of the gesture recognition authority may be further extended to a passenger in a back seat as well as a passenger in the passenger seat 22 (e.g., front seat). In particular, an algorithm by which the image analysis unit 120 determines to whom the object 1 of interest belongs may be omitted, and the controller 131 may be configured to directly recognize a gesture expressed by the object 1 of interest.

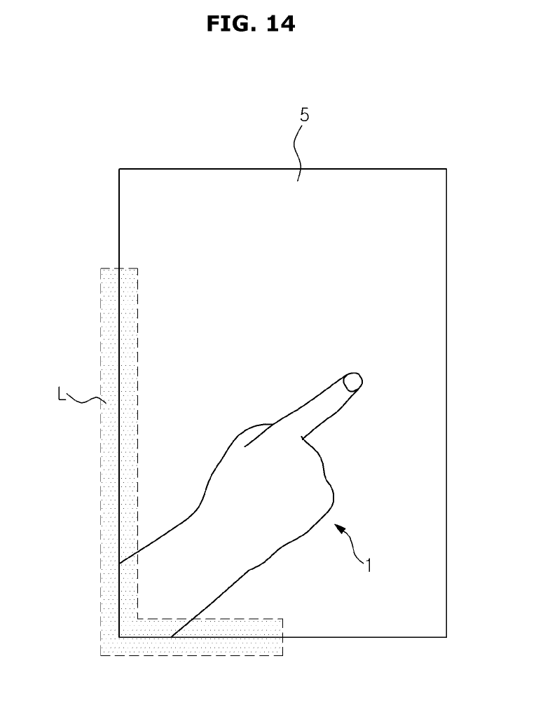

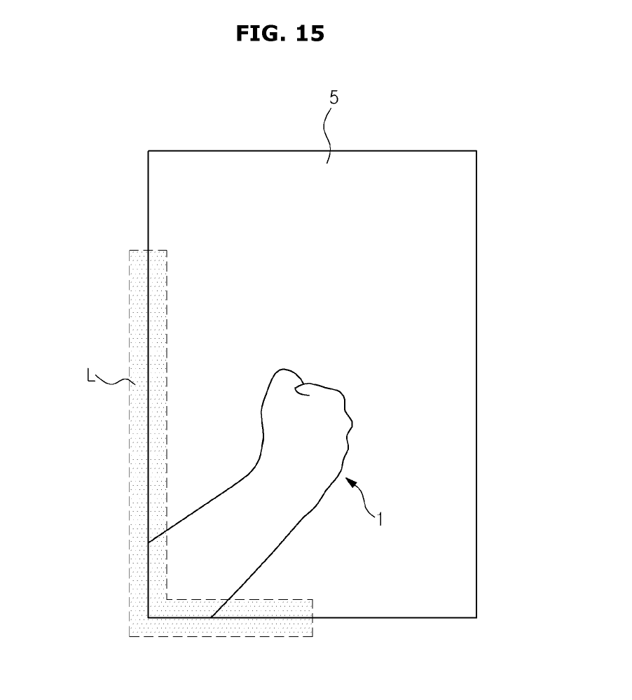

FIGS. 14 and 15 illustrate an exemplary specific gesture to retrieve the gesture recognition authority from the passenger. As described above, to change the gesture recognition authority, a specific gesture and an operation to change the gesture recognition authority may be stored in the memory 132 in a mapping mode. The changing of the gesture recognition authority may include restricting the gesture recognition authority back to the passenger. For example, a motion in which a hand is repeatedly opened and closed and an operation to restrict the gesture recognition authority back to the driver may be stored in the memory 132 in a mapping mode.

Accordingly, as illustrated in FIG. 14, when the object 1 of interest belongs to the driver and a gesture expressed by the object 1 of interest is a motion in which a hand is repeatedly opened and closed, the controller 131 may be configured to recognize the gesture expressed by the object 1 of interest and restrict the gesture recognition authority back to the driver. After the gesture recognition authority is restricted back to the driver, the image analysis unit 120 may be configured to determine whether the object 1 of interest in the gesture area 5 belongs to the driver. The controller 131 may be configured to recognize the gesture expressed by the object 1 of interest and execute an operation corresponding thereto when the object 1 of interest belongs to the driver.

As another example, a pose in which a hand is closed and an operation to restrict the gesture recognition authority back to the driver may be stored in the memory 132 in a mapping mode. Accordingly, as illustrated in FIG. 15, when the object 1 of interest belongs to the driver and a gesture expressed by the object 1 of interest is a pose in which a hand is closed, the controller 131 may be configured to recognize the gesture expressed by the object 1 of interest and restrict the gesture recognition authority back to the driver.

As described above, the driver may appropriately change control authority of the vehicle 100 by changing a holder of gesture recognition authority using a gesture. The gestures illustrated in FIGS. 12, 14, and 15 are merely exemplary gestures to change the gesture recognition authority, and exemplary embodiments of the present invention are not limited thereto. In addition to the above gestures, various driver gestures recognizable by the controller 131 may be used.

A description is now given of a method for controlling a vehicle, according to an exemplary embodiment of the present invention. The vehicle 100 according to the previous embodiments is applicable to the method according to the current exemplary embodiment, and thus the descriptions given above in relation to FIGS. 1 to 15 are also applicable to the method to be described below.

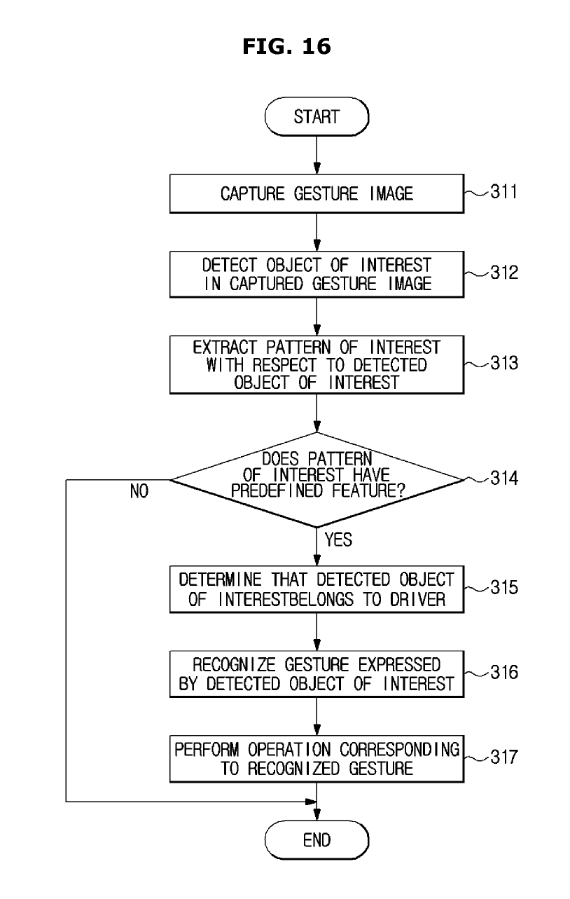

FIG. 16 is an exemplary flowchart of a method for controlling the vehicle 100, according to an exemplary embodiment of the present invention. Referring to FIG. 16, initially, a gesture image may be captured using the image capturing unit 110 (311). The gesture image may be obtained by photographing the gesture area 5 which includes a body part of a driver performing a gesture. In the current exemplary embodiment, the body part of the driver performing a gesture may be the hand. Accordingly, the gesture image captured by the image capturing unit 110 may be an image that includes a driver hand. An object of interest may be detected in the captured gesture image (312). In the current exemplary embodiment, the object of interest may be a hand of a user, and the user may include the driver and a passenger.

When the object of interest is detected, a pattern of interest may be extracted with respect to the detected object of interest (313). The pattern of interest may include a wrist connection pattern formed by connecting a specific point of an arm and a wrist point, a finger pattern indicating the relationship between fingers, etc. Specifically, referring to FIG. 7, the wrist connection pattern a-b formed by connecting the arm end point a in the gesture area 5 and the wrist point b may be extracted as the pattern of interest. In addition, as illustrated in FIG. 8, the first finger pattern b-c formed by connecting the wrist point b and the thumb end point c, and the second finger pattern b-d formed by connecting the wrist point b and the other finger end point d may also be extracted as the pattern of interest.

Whether the extracted pattern of interest has a predefined feature may also be determined (314). For example, as illustrated in FIG. 7, the controller may be configured to determine whether the wrist connection pattern a-b starts from the left side of the gesture area 5 and, more particularly, whether the arm end point a of the wrist connection pattern a-b is located in the left boundary area L. Alternatively, as illustrated in FIG. 8, the controller may be configured to determine whether the first finger pattern b-c is located at the left side of the second finger pattern b-d.

When the pattern of interest has the predefined feature (Yes in 314), the controller may be configured to determine that the detected object of interest belongs to the driver (315). Then, a gesture expressed by the detected object of interest may be recognized (316), and an operation that corresponds to the recognized gesture may be performed (317). The operation that corresponds to the recognized gesture may be pre-stored in the memory 132, and may be set or changed by the user.

Meanwhile, the driver may appropriately change control authority of the vehicle 100 by changing a holder of gesture recognition authority using a gesture. Accordingly, a specific gesture and an operation to extend the holder of the gesture recognition authority may be stored in a mapping mode, and the gesture recognition authority may be further given to the passenger when the specific gesture (e.g., a first specific gesture) is recognized. In other words, the holder of the gesture recognition authority may be extended to the passenger. In addition, the gesture recognition authority may be restricted back to the driver. Another specific gesture that corresponds thereto may be stored and the holder of the gesture recognition authority may be restricted back to the driver when the other (e.g., the second) specific gesture is recognized.

In the above-described vehicle and the method for controlling the same, malfunction or inappropriate operation of the vehicle due to a passenger error may be prevented by distinguishing a gesture of a driver from that of the passenger when a gesture of a user is recognized. As is apparent from the above description, in a vehicle and a method for controlling the same, according to exemplary embodiments of the present invention, malfunction or inappropriate operation of the vehicle due to a passenger may be prevented by distinguishing a gesture of a driver from that of the passenger when a gesture of a user is recognized.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A vehicle, comprising:
an image capturing unit mounted inside the vehicle and configured to capture a gesture image of a gesture area including a driver gesture or a passenger gesture; and
a controller configured to:
detect an object of interest in the gesture image captured by the image capturing unit;
determine whether the object of interest belongs to the driver;
recognize a gesture expressed by the object of interest; and
generate a control signal that corresponds to the gesture when the object of interest belongs to the driver.

2. The vehicle according to claim 1, wherein the controller is configured to extract a pattern of interest with respect to the object of interest and determine whether the pattern of interest has a predefined feature.

3. The vehicle according to claim 2, wherein the controller is configured to determine that the object of interest belongs to the driver when the pattern of interest has the predefined feature.

4. The vehicle according to claim 3, wherein the object of interest is an arm or a hand of a person.

5. The vehicle according to claim 4, wherein the pattern of interest includes a wrist connection pattern formed by connecting an end of the arm and a wrist which is a connection part between the arm and the hand.

6. The vehicle according to claim 5, wherein the predefined feature includes a feature in which the wrist connection pattern starts from a left or right side of the gesture area.

7. The vehicle according to claim 6, wherein, when the vehicle is a left hand drive (LHD) vehicle, the controller is configured to determine that the object of interest belongs to the driver when the wrist connection pattern starts from the left side of the gesture area.

8. The vehicle according to claim 6, wherein, when the vehicle is a right hand drive (RHD) vehicle, the controller is configured to determine that the object of interest belongs to the driver when the wrist connection pattern starts from the right side of the gesture area.

9. The vehicle according to claim 4, wherein the pattern of interest includes:
a first finger pattern formed by connecting a wrist which is a connection part between the arm and the hand, and a thumb end of the hand; and
a second finger pattern formed by connecting the wrist and another finger end of the hand.

10. The vehicle according to claim 9, wherein the predefined feature includes a feature in which the first finger pattern is located at a left or right side of the second finger pattern.

11. The vehicle according to claim 10, wherein, when the vehicle is an LHD vehicle, the controller is configured to determine that the object of interest belongs to the driver when the first finger pattern is located at the left side of the second finger pattern.

12. The vehicle according to claim 10, wherein, when the vehicle is an RHD vehicle, the controller is configured to determine that the object of interest belongs to the driver when the first finger pattern is located at the right side of the second finger pattern.

13. The vehicle according to claim 3, further comprising:
a memory configured to store specific gestures and specific operations in a mapping mode.

14. The vehicle according to claim 13, wherein the controller is configured to search the memory for a specific gesture that corresponds to the gesture expressed by the object of interest, and generate a control signal to execute a specific operation mapped to a found specific gesture.

15. The vehicle according to claim 14, wherein the memory is configured to store a specific gesture and an operation to change gesture recognition authority in a mapping mode.

16. The vehicle according to claim 15, wherein the controller is configured to generate a control signal to change the gesture recognition authority when the gesture expressed by the object of interest corresponds to the specific gesture.

17. The vehicle according to claim 16, wherein the changing of the gesture recognition authority comprises:
extending, by the controller, a holder of the gesture recognition authority to the passenger; and
restricting, by the controller, the holder of the gesture recognition authority to the driver.

18. A method for controlling a vehicle, the method comprising:
capturing, by an imaging device, a gesture image of a gesture area comprising a gesture of a driver or a passenger;
detecting, by a controller, an object of interest in the captured gesture image of the gesture area;
determining, by the controller, whether the object of interest belongs to the driver; and
recognizing, by the controller, a gesture expressed by the object of interest and generating a control signal that corresponds to the gesture when the object of interest belongs to the driver.

19. The method according to claim 18, further comprising:
extracting, by the controller, a pattern of interest with respect to the object of interest; and
determining, by the controller, that the object of interest belongs to the driver when the pattern of interest has a predefined feature.

20. The method according to claim 19, wherein the object of interest is an arm or a hand of a person, and wherein the pattern of interest includes a wrist connection pattern formed by connecting an end of the arm and a wrist which is a connection part between the arm and the hand.

21. The method according to claim 20, wherein the predefined feature includes a feature in which the wrist connection pattern starts from a left or right side of the gesture area.

22. The method according to claim 19, wherein the object of interest is an arm or a hand of a person, and wherein the pattern of interest includes:
a first finger pattern formed by connecting a wrist which is a connection part between the arm and the hand, and a thumb end of the hand; and
a second finger pattern formed by connecting the wrist and another finger end of the hand.

23. The method according to claim 22, wherein the predefined feature includes a feature in which the first finger pattern is located at a left or right side of the second finger pattern.

24. A non-transitory computer readable medium containing program instructions executed by a processor or controller, the computer readable medium comprising:
program instructions that control an imaging device to capture a gesture image of a gesture area comprising a gesture of a driver or a passenger;
program instructions that detect an object of interest in the captured gesture image of the gesture area;
program instructions that determine whether the object of interest belongs to the driver; and
program instructions that recognize a gesture expressed by the object of interest and generating a control signal that corresponds to the gesture when the object of interest belongs to the driver.

25. The non-transitory computer readable medium of claim 24, further comprising:
program instructions that extract a pattern of interest with respect to the object of interest; and
program instructions that determine that the object of interest belongs to the driver when the pattern of interest has a predefined feature.
